(19) United States
(12) Patent Application Publication
(10) Pub. No.: US 2011/0156808 A1
(43) Pub. Date: Jun. 30, 2011

(54) INTERNAL VOLTAGE GENERATION CIRCUIT

(76) Inventors: Jong-Man IM, Gyeonggi-do (KR); Ki-Chang Kwean, Gyeonggi-do (KR)

(21) Appl. No.: 12/649,515

(22) Filed: Dec. 30, 2009

(30) Foreign Application Priority Data
Dec. 29, 2009 (KR) 10-2009-0133464

(51) Int. Cl. G05F 1/10

(52) U.S. Cl. 327/543

(57) ABSTRACT

An internal voltage generation circuit includes a first voltage generation unit configured to be operated in response to a first power enable signal to generate a first voltage, a level detection unit configured to detect a level of the first voltage, and a second voltage generation unit configured to be operated in response to a level detection value outputted from the level detection unit to generate a second voltage lower than the first voltage.

### CROSS-REFERENCE TO RELATED APPLICATIONS

The present application claims priority of Korean Patent Application No. 10-2009-0133464, filed on Dec. 29, 2009, which is incorporated herein by reference in its entirety.

### BACKGROUND OF THE INVENTION

Exemplary embodiments of the present invention relate to an internal voltage generation circuit having a simple circuit configuration by reducing the number of voltages used therein.

Semiconductor devices are used in various fields. As one example, semiconductor devices are used to store a variety of data. Since such semiconductor devices are used in a variety of portable devices, including desktop computers and notebook computers, high capacity, high speed operation, miniaturization, and low power are desired.

Semiconductor devices may use internal voltages having various levels, which may be generated using an external power supply voltage. Specifically, semiconductor memory devices (e.g., DRAM) may generate a VCORE voltage, which is used in a core area, a VPP voltage higher than an external power supply voltage (VDD), which is applied to a gate of a cell transistor (word line), and a negative voltage (VBB) lower than a ground voltage (VSS), which is used in a bulk of a cell transistor.

Another of such internal voltages is a VPPY voltage. The VPPY voltage is a voltage which may be supplied to a gate of a BLEQ transistor provided in a sense amplifier. In order to efficiently control the equalization of a bit line BL and a bit bar line /BLB, the VPPY voltage, which is higher the VDD voltage and lower than the VPP voltage, is used.

Furthermore, in low-power products, a VPPYCLP voltage has been used for biasing a BLEQ transistor. The VPPYCLP voltage may be generated by clamping the VPPY voltage in order to prevent a latch-up effect. Therefore, a conventional semiconductor device simultaneously includes the VPP voltage, the VPPY voltage, and the VPPYCLP voltage to be supplied to a BLEQ transistor of the sense amplifier.

FIG. 1 illustrates a conventional control circuit for generating a VPPY voltage in an initial operation, and a conventional control circuit for generating a VPP voltage in an initial operation.

The VPP voltage is generated by turning on an NMOS transistor N4 in response to a power-up signal PWRUP, and shorting a VDD voltage terminal and a VPP voltage terminal in an initial operation. The VPPY voltage is generated by turning on an NMOS transistor N5 in response to a power-up signal PWRUP, and shorting a VDD voltage terminal and a VPPY voltage terminal in an initial operation.

As illustrated in a characteristic diagram of FIG. 3, the VPP voltage, and the VPPY voltage are shorted with the VDD voltage in a power-up section, and increase with a voltage level increase of the VDD voltage. However, after the trigger time of the power-up signal, a latch-up effect may occur because the VPPY voltage is pumped more rapidly than the VPP voltage, and thus, the VPPY voltage increases faster than the VPP voltage.

To address this concern, a BLEQ bias circuit is provided to prevent a latch-up effect by using a VPPCLP voltage.

FIG. 2 illustrates a conventional BLEQ bias circuit for suppressing a latch-up effect.

Referring to FIG. 2, an NMOS transistor N2 is connected to a VPPY terminal and configured to receive a VPP voltage at a gate thereof to generate a VPPYCLP voltage. A PMOS transistor P2 and an NMOS transistor N3 are connected in series between an output terminal of the NMOS transistor N2 and a ground voltage (VSS) terminal and configured to generate voltages BLEQ and BLEQB supplied to a gate of a BLEQ transistor of a sense amplifier. The BLEQ voltage may be applied at a terminal coupled to the gates of the PMOS transistor P2 and the NMOS transistor N3, while the BLEQb voltage may be applied at a terminal in series with and between the PMOS transistor P2 and the NMOS transistor N3.

The VPP voltage and the VPPY voltage are shorted with the VDD voltage. When the VPP voltage becomes higher than the VPPY voltage, the NMOS transistor N2 is turned on so that the VPPYCLP voltage is generated. The control of the BLEQ bias circuit is controlled after the generation of the VPPYCLP and generates the BLEQ bias voltage.

A conventional internal voltage generation circuit uses the VPP voltage, the VPPY voltage, and the VPPCLP voltage in order to generate the BLEQ bias, and therefore, has all of the circuitry needed to use these voltages. Such circuitry makes it difficult to miniaturize the products, causing the consumer's dissatisfaction.

### SUMMARY OF THE INVENTION

Exemplary embodiments of the present invention are directed to an internal voltage generation circuit which may be simply configured by simplifying types of voltages used therein.

In accordance with an embodiment of the present invention, an internal voltage generation circuit includes a first voltage generation unit configured to be operated in response to a first power enable signal to generate a first voltage, a level detection unit configured to detect a level of the first voltage, and a second voltage generation unit configured to be operated in response to a level detection value outputted from the level detection unit to generate a second voltage lower than the first voltage.

The internal voltage generation circuit may further include a reset unit configured to generate the first voltage equal to a power supply voltage in an initial operation.

The reset unit may include a driver configured to be turned on in response to a power up signal and short the power supply voltage and the first voltage.

The driver may include an NMOS transistor.

The power enable signal may be generated at a trigger time of the power up signal.

The internal voltage generation circuit may further include a reset unit configured to generate a second voltage lower than a power supply voltage by a predetermined voltage level in an initial operation.

The reset unit may include a driver configured to be turned on in response to the power supply voltage and generate the second voltage having a voltage level lower than the power supply voltage by a threshold voltage.

The level detection unit may include a first divider configured to divide the first voltage to generate a division voltage and a comparator configured to compare the division voltage with a reference voltage and generate the level detection value.

The first voltage generation unit may pump a power supply voltage to generate the first voltage when a power-up signal may be trigger.

The first voltage may be a VPP voltage higher than the power supply voltage, and the second voltage may be a VPPY voltage lower than the VPP voltage.

The second voltage generation unit may include a pump unit configured to be enabled in response to the level detection value to pump a power supply voltage to generate the second voltage.

In accordance with another embodiment of the present invention, an internal voltage generation circuit includes a first voltage generation unit configured to be operated in response to a first power enable signal to generate a first voltage, and a second voltage generation unit configured to be operated in response to a second power enable signal to generate a second voltage lower than the first voltage, the second power enable signal being generated relatively later than the first power enable signal.

The internal voltage generation circuit may further include a first reset unit configured to be operated in response to a first power up signal to generate the first voltage equal to a power supply voltage in an initial operation.

The reset unit may include a driver configured to be turned on in response to the first power up signal and short the power supply voltage and the first voltage.

The first power enable signal may be generated at a trigger time of the first power up signal.

The internal voltage generation circuit may include a second reset unit configured to generate the second voltage lower than a power supply voltage by a predetermined voltage level in an initial operation.

The reset unit may include a driver configured to be turned on in response to the power supply voltage and generate the second voltage having a voltage level lower than the power supply voltage by a threshold voltage.

The second power enable signal may be generated at a trigger time of the second power up signal being activated relatively later than the first power up signal.

The first voltage generation unit configured to pump the power supply voltage to generate the first voltage in response to the first power enable signal.

The first power enable signal may include a power-up pre signal generated relatively earlier than a power-up signal.

### BRIEF DESCRIPTION OF THE DRAWINGS

FIG. 1 is a circuit diagram of a reset unit of a conventional internal voltage generation circuit.

FIG. 2 is a circuit diagram of a conventional BLEQ bias circuit for suppressing a latch-up effect.

FIG. 3 is a graph showing a conventional voltage change characteristic with respect to a trigger time of a power-up signal.

FIG. 4 is a block diagram of an internal voltage generation circuit in accordance with a first embodiment of the present invention.

FIG. 5 is a circuit diagram of a VPP level detection unit illustrated in FIG. 4.

FIG. 6 is a graph showing a voltage change characteristic in accordance with an embodiment of the present invention.

FIG. 7 is a circuit diagram of a VPPY reset unit in accordance with the first embodiment of the preset invention.

FIG. 8 is a circuit diagram of a VPP voltage reset unit in accordance with the first embodiment of the present invention.

FIG. 9 is a circuit diagram of a BLEQ bias unit in accordance with the embodiment of the present invention.

FIG. 10. is a block diagram of an internal voltage generation circuit in accordance with a second embodiment of the present invention.

FIG. 11 is a circuit diagram of a VPPY voltage reset unit in accordance with the second embodiment of the present invention.

FIG. 12 is a circuit diagram of a power-up signal/power-up pre signal generation unit in accordance with the second embodiment of the present invention.

FIG. 13 is a graph showing a power-up signal/a power-up pre signal.

FIG. 14 is a graph showing a voltage change characteristic in accordance with the second embodiment of the present invention.

FIG. 15 is a circuit diagram of a VPP voltage reset unit in accordance with the second embodiment of the present invention.

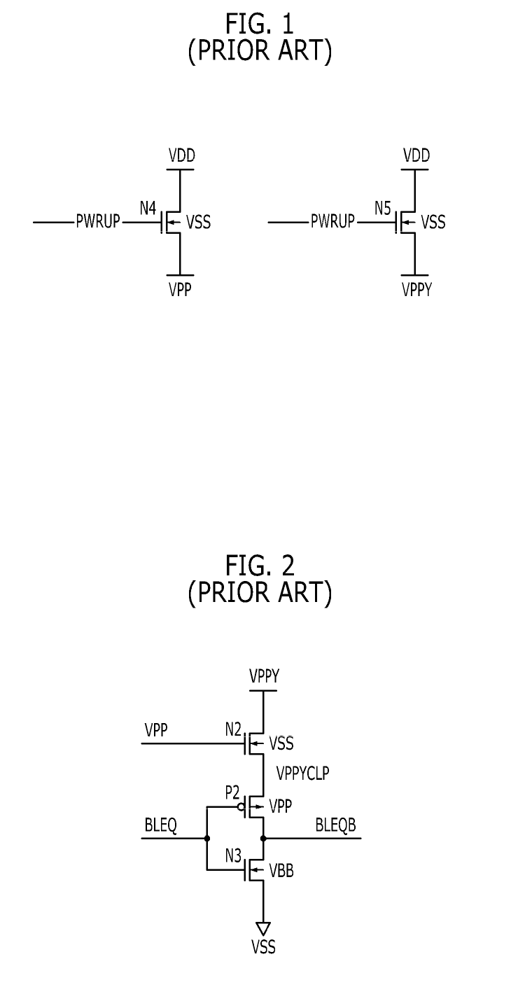

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention. The drawings are not necessarily to scale and in some instances, proportions may have been exaggerated in order to clearly illustrate features of the embodiments.

A first embodiment of the present invention provides an internal voltage generation circuit necessary for BLEQ bias of a sense amplifier. A VPPY voltage and a VPP voltage are required for the BLEQ bias of the sense amplifier. The VPPY voltage is supplied to a gate of a BLEQ transistor provided in the sense amplifier. In order to efficiently control the equalization of a bit line BL and a bit bar line /BLB, the VPPY voltage, which is higher the VDD voltage and lower than the VPP voltage, is used.

Furthermore, in low-power products, a VPPYCLP voltage has been used for biasing a BLEQ transistor. The VPPYCLP voltage is generated by clamping the VPPY voltage in order to prevent a latch-up effect.

However, in accordance with the first embodiment of the present invention, the VPPY voltage is prevented from increasing higher than the VPP voltage at a point in time when a latch-up occurs (i.e., a point in time when a power-up trigger signal is generated). Therefore, the internal voltage generation circuit in accordance with the first embodiment of the present invention does not require the VPPYCLP voltage which has been used in conventional internal voltage generation circuits.

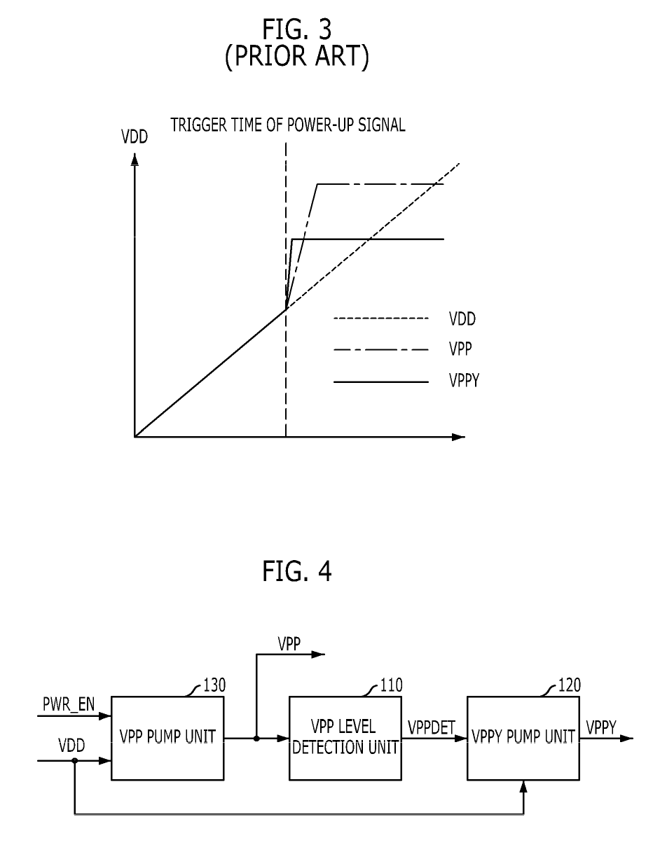

FIG. 4 is a block diagram of an internal voltage generation circuit for generating a VPPY voltage and a VPP voltage in accordance with a first embodiment of the present invention.

Referring to FIG. 4, the internal voltage generation circuit includes a VPP pump unit 130 configured to be enabled at a trigger time of a power-up signal to perform a pumping operation for generating a VPP voltage. Thus, a power enable signal PWR_EN provided to the VPP pump unit 130 is generated at a trigger time of the power-up signal. The VPP pump unit 130 pumps a power supply voltage VDD to generate a boosted voltage. The VPP pump unit 130 may be a typical boosted voltage generator.

In addition, the internal voltage generation circuit includes a VPP level detection unit 110 and a VPPY pump unit 120. The VPP level detection unit 110 is configured to detect whether the VPP voltage generated from the VPP pump unit 130 is sufficiently boosted. The VPPY pump circuit 120 is configured to perform a pumping operation for generating a VPPY voltage in response to a detection signal VPPDET outputted from the VPP level detection unit 110. That is, the detection signal VPPDET outputted from the VPP level detection unit 110 is used as an enable signal of the VPPY pump circuit 120.

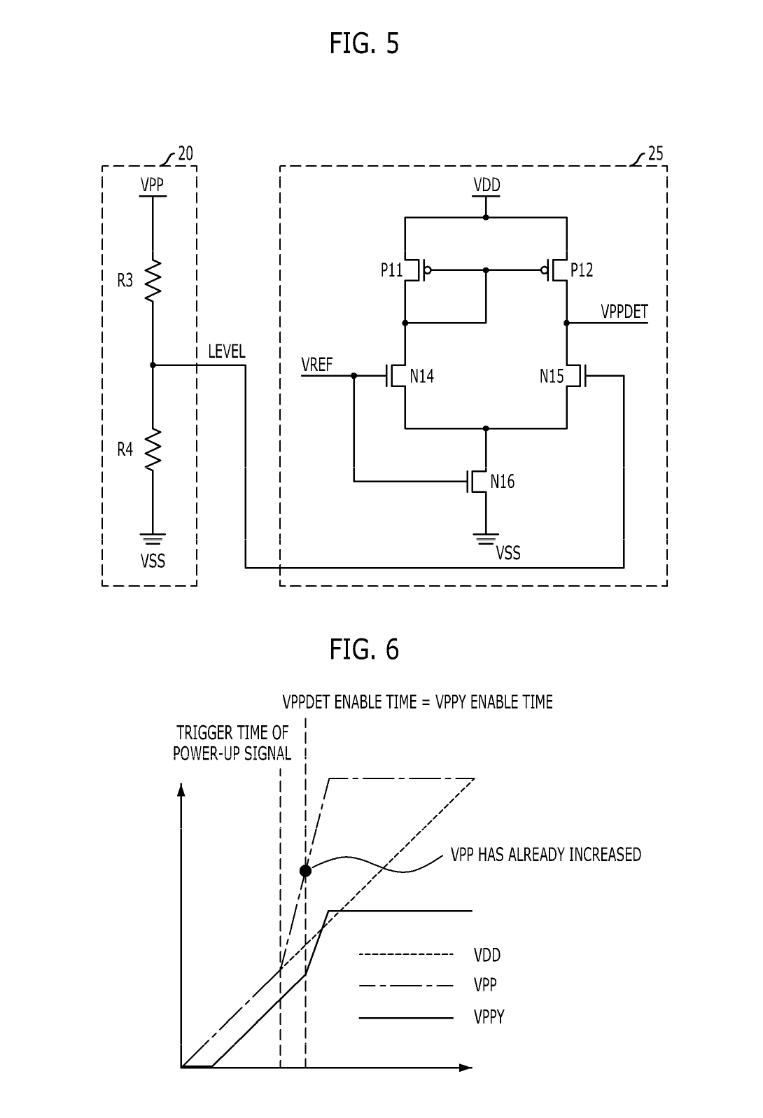

FIG. 5 is a circuit diagram of a VPP level detection unit 110 illustrated in FIG. 4. Referring to FIG. 5, the VPP level detection unit 110 includes a voltage divider 20 and a comparator 25. The voltage divider 20 includes resistors R3 and R4 connected in series between a VPP terminal and a VSS terminal. The comparator 25 is configured to compare a reference voltage VREF with a division voltage LEVEL outputted from the voltage divider 20. Further, the comparator 25 is configured to generate the detection signal VPPDET indicating whether or not the VPP voltage is boosted by more than a predetermined level.

The comparator 25 includes an input section, an NMOS transistor N16, and PMOS transistors P11 and P12. The input section is configured with NMOS transistors N14 and N15, which receive the reference voltage VREF and the division voltage LEVEL, at their gates, respectively. The NMOS transistor N16 is connected between the input section and the VSS terminal, and configured to be biased by the reference voltage VREF to enable the comparator 25. The PMOS transistors P11 and P12 constitute a current mirror type precharge section connected to the VDD terminal.

Although not illustrated in FIG. 4, the internal voltage generation circuit for generating the VPPY voltage and the VPP voltage further includes a VPPY and VPP voltage reset unit for generating the VPPY voltage and the VPP voltage before the enable time of the power-up signal.

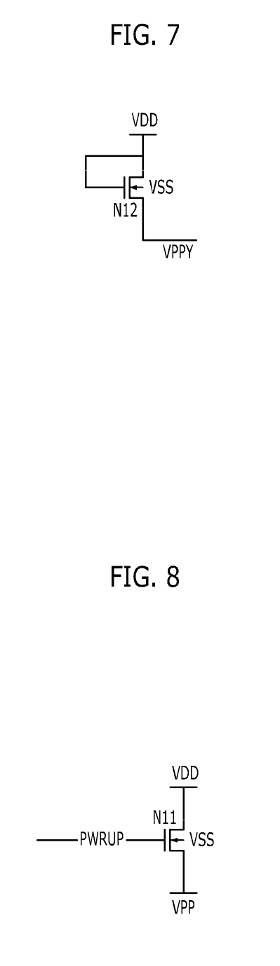

Referring to FIG. 7, a VPPY voltage reset unit includes a driver implemented with an NMOS transistor N12 between the VDD terminal and the VPPY terminal. Also, the gate of the NMOS transistor N12 is connected to the VDD terminal. In the initial operation, the VPPY voltage changes from the VDD voltage level to a voltage level lower than a threshold voltage (Vt).

Referring to FIG. 8, a VPP voltage reset unit includes a driver implemented with an NMOS transistor N11 between the VDD terminal and the VPP terminal. The power-up signal is applied to a gate of the NMOS transistor N11. In the initial operation, the VPP voltage is shorted with the VDD voltage through the NMOS transistor N11.

As illustrated in the characteristic graph of FIG. 6, the VPP voltage is generated by shorting the VDD voltage and the VPP voltage through the NMOS transistor N11 configured to be turned on in response to the power-up signal in the initial operation. Therefore, in the initial operation, the VPP voltage level is equal to the VDD level. Thereafter, the pumping operation of the VPP pump unit 130 is performed by the enable signal generated at a trigger time of the power-up signal, and thus, the VPP voltage level increases.

Meanwhile, the VPPY voltage is generated by shorting the VDD voltage and the VPPY voltage through the NNMOS transistor N13 configured to be turned on in response to the VDD voltage in the initial operation. The generated VPPY voltage maintains a voltage level lower than the VDD voltage by a threshold voltage (Vt) for turning on the NMOS transistor N12.

The characteristic graph of the VPPY voltage level is illustrated in FIG. 6. As illustrated, the VPPY voltage level maintains a voltage level lower than the VDD voltage by a threshold voltage (Vt) for turning on the NMOS transistor N12, until a detection signal VPPDET is generated.

Thereafter, when the VPP voltage increases, the voltage divider 20 divides the VPP voltage to generate a division voltage LEVEL, and the comparator 25 generates the detection signal VPPDET, when it is detected that the division voltage LEVEL is higher than the reference voltage VREF. The detection signal VPPDET detected by VPP level detection unit 110 is provided to the VPPY pump unit 120 as the enable signal, and the VPPY pump unit 120 pumps the VDD voltage to generate the VPPY voltage.

Therefore, when generating the VPPY voltage, the VPPY pump unit 120 is controlled to operate when the VPP voltage level sufficiently increases. Due to such a configuration, the VPPY voltage level is kept at a voltage level lower than the VPP voltage level.

As illustrated in FIG. 6, the generation of the VPPY voltage is achieved by controlling the pumping operation of the VPPY voltage after the VPPY voltage level increases higher than a predetermined voltage level. Thus, the VPPY voltage level is always maintained at a voltage level lower than the VPP voltage level.

Furthermore, the VPPY voltage level is compared with the VPP voltage level having the same voltage level as the VDD voltage level, and maintained at a voltage level lower than the threshold voltage (Vt) from the initial operation. In this manner, the difference of the threshold voltage level is continued until the enable signal, supplied to the VPP pump unit 130, is generated (such generation occurs at the trigger time of the power-up signal). After triggering the power-up signal, the levels of the VPPY voltage and the VPP voltage are increased by the pumping operation.

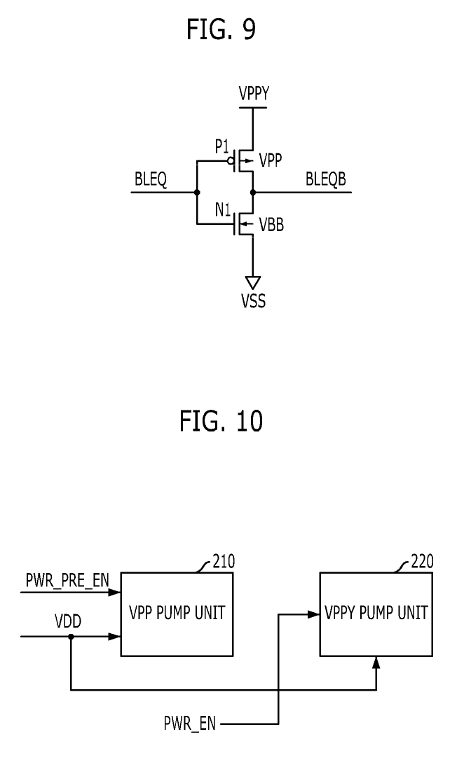

Therefore, as illustrated in FIG. 9, the BLEQ bias of the sense amplifier may be generated by using only the VPP voltage and the VPPY voltage. Thus, the generation of the VPPCLP voltage which has been obtained in the conventional technology by clamping the VPPY voltage is unnecessary, and therefore, the conventional circuit design of the BLEQ bias circuit is also unnecessary.

A second embodiment of the present invention provides an internal voltage generation circuit necessary for BLEQ bias of a sense amplifier. As described above, a VPPY voltage and a VPP voltage are required for the BLEQ bias of the sense amplifier. Further, in the conventional technology, a VPPYCLP voltage obtained by clamping the VPPY voltage is additionally used for preventing a latch-up effect.

However, in accordance with the second embodiment of the present invention, the VPPY voltage is generated by controlling the pumping operation for the VPPY voltage generation from a point in time when a power-up trigger signal is generated (i.e., when an enable signal is generated), and the VPPY voltage is generated by controlling the pumping operation for the VPP voltage generation by using a power-up pre signal (PWRUP_PRE) before using the power-up trigger signal (i.e., at a lower voltage level than the power-up signal in a DC view). Since the VPP voltage level is always kept at a level higher than the VPPY voltage level, the internal voltage generation circuit in accordance with the second embodiment of the present invention does not require the VPPYCLP voltage which has been used in conventional internal voltage generation circuits.

FIG. 10 is a block diagram of an internal voltage generation circuit for generating a VPPY voltage and a VPP voltage in accordance with a second embodiment of the present invention.

Referring to FIG. 10, the internal voltage generation circuit includes a VPPY pump unit 220 configured to be enabled at a trigger time of a power-up signal to perform a pumping operation for generating a VPPY voltage. Thus, a power enable signal PWR_EN provided to the VPPY pump unit 220 is generated at a point in time when a power-up signal is triggered. The VPPY pump unit 220 pumps a power supply voltage VDD to generate a boosted voltage VPPY. The VPPY pump unit 220 may be a typical boosted voltage generator.

In addition, the internal voltage generation circuit includes a VPP pump unit 210 configured to be operated in response to a power pre-enable signal PWR_PRE_EN, which is generated relatively earlier than the power enable signal PWR_EN of the VPPY pump unit 220. The power pre-enable signal PWR_PRE_EN is activated at a time of a lower voltage than the power up signal.

Therefore, the power pre-enable signal PWR_PRE_EN provided to the VPP pump unit 210 is generated at the trigger time of the power-up pre signal. Further, the VPP pump unit 210 is operated in response to the power pre-enable signal PWR_PRE_EN to generate the VPP voltage through the pumping operation of the VDD voltage.

Although not illustrated in FIG. 10, the internal voltage generation circuit further includes a VPPY voltage reset unit and a VPP voltage reset unit.

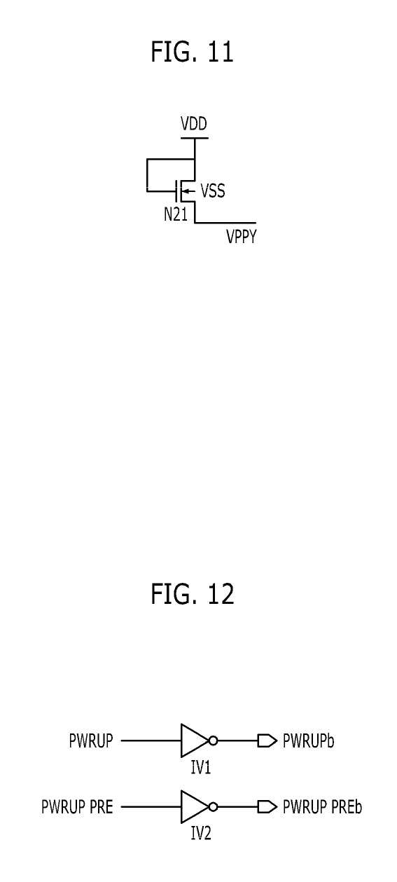

FIG. 11 is a circuit diagram of a VPPY voltage reset unit in accordance with the second embodiment of the present invention. Referring to FIG. 11, a VPPY voltage reset unit includes a driver implemented with an NMOS transistor N21 between the VDD terminal and the VPPY terminal. A gate of the NMOS transistor N21 is connected to the VDD terminal. In the initial operation, the VPPY voltage changes from the VDD voltage level to a voltage level lower than a threshold voltage (Vt).

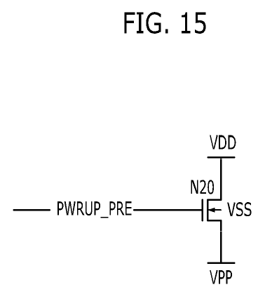

FIG. 15 is a circuit diagram of a VPP voltage reset unit in accordance with the second embodiment of the present invention. Referring to FIG. 15, a VPP voltage reset unit includes a driver implemented with an NMOS transistor N20 between the VDD terminal and the VPP terminal. The power-up pre signal PWRUP_PRE is applied to a gate of the NMOS transistor N20. In the initial operation, the VPP voltage is shorted with the VDD voltage through the NMOS transistor N20.

According to the above-described configuration, the VPPY voltage is generated by shorting the external VDD voltage and the VPPY voltage through the NMOS transistor N21 configured to be turned on in response to the VDD voltage in the initial operation. The generated VPPY voltage maintains a voltage level lower than the VDD voltage by a threshold voltage (Vt) for turning on the NMOS transistor N21.

The characteristic graph of the VPPY voltage level is illustrated in FIG. 14. As illustrated, the VPPY voltage level maintains a voltage level lower than the external VDD voltage by the threshold voltage (Vt) for turning on the NMOS transistor N21 until before the trigger time of the power-up signal.

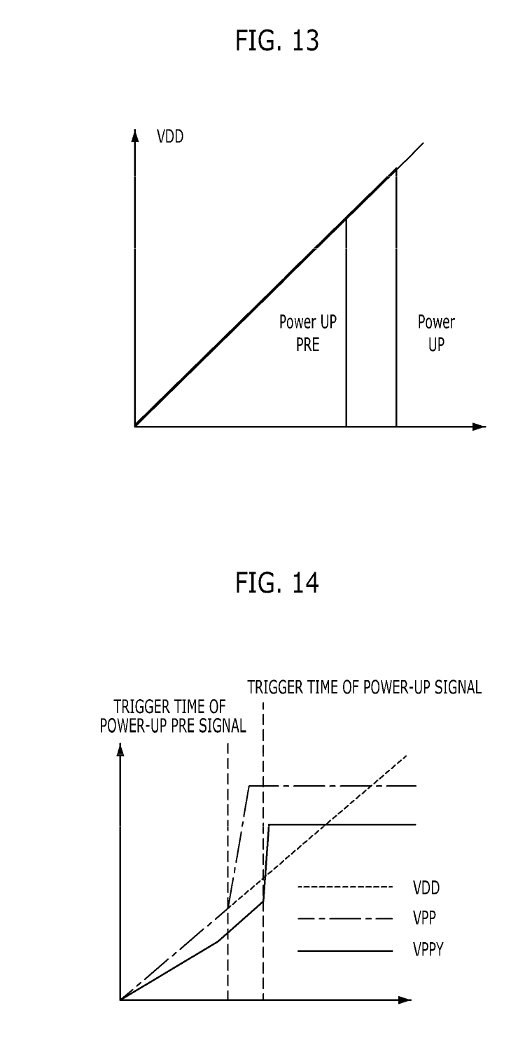

Thereafter, the power-up signal is triggered, and the power enable signal PWR_EN is provided to the VPPY pump unit 220. Then, the VPPY pump unit 220 pumps the VDD voltage to generate the VPPY voltage. As illustrated in FIG. 13, the power enable signal PWR_EN generated at the trigger time of the power signal is supplied later than the power-up pre signal by a predetermined time. Therefore, the VPPY voltage level is always maintained lower than the VPP voltage level.

As illustrated in FIG. 12, the power-up signal and the power-up pre signal provided to the internal voltage generation circuit are delayed by a desired time using an operation device, such as an inverter (see inverters IV1 and IV2 shown in FIG. 12).

As illustrated in the characteristic diagram of FIG. 14, the VPP voltage is generated by shorting the VDD voltage and the VPP voltage, configured to be turned on in response to the power-up pre signal, through the NMOS transistor N20 in the initial operation. Therefore, the VPP voltage level is equal to the VDD voltage level, before the trigger time of the power-up pre signal.

Thereafter, the pumping operation of the VPP pump unit 210 is performed in response to the enable signal PWR_PRE_EN generated at the trigger time of the power-up pre signal, and thus, the VPP voltage level increases.

As illustrated in FIGS. 12 and 13, the enable signal provided for the VPP voltage generation is generated at the trigger time of the power-up pre signal. Further, the power-up pre signal is generated earlier than the power-up signal. Therefore, the VPP voltage generation operation is performed earlier than the VPPY voltage generation operation. As illustrated in the characteristic diagram of FIG. 14, the generated VPP voltage level increases relatively earlier than the VPPY voltage level.

Therefore, as illustrated in FIG. 9, the BLEQ bias of the sense amplifier may be generated by using only the VPP voltage and the VPPY voltage. Thus, the generation of the VPPCLP voltage which has been obtained in the past by clamping the VPPY voltage is unnecessary, and therefore, the past circuit design of the BLEQ bias circuit is also unnecessary.

In accordance with the exemplary embodiments of the present invention, the number of voltages used in the internal voltage generation circuit for generating the sense amplifier BLEQ bias voltage is reduced, and the power line structure is flexibly adjusted. Thus, products suitable for miniaturization and lower power consumption may be implemented.

The above-described embodiments are described for exemplary purposes. Accordingly, the sense amplifier BLEQ bias unit may also be implemented such that the VPP voltage is always higher than the VPPY voltage.

While the present invention has been described with respect to the specific embodiments, it will be apparent to those skilled in the art that various changes and modifications may be made without departing from the spirit and scope of the invention as defined in the following claims.

What is claimed is:

1. An internal voltage generation circuit, comprising:
a first voltage generation unit configured to be operated in response to a power enable signal to generate a first voltage;
a level detection unit configured to detect a level of the first voltage; and
a second voltage generation unit configured to be operated in response to a level detection value outputted from the level detection unit to generate a second voltage lower than the first voltage.

2. The internal voltage generation circuit of claim 1, further comprising a reset unit configured to generate the first voltage equal to a power supply voltage in an initial operation.

3. The internal voltage generation circuit of claim 2, wherein the reset unit comprises a driver configured to be turned on in response to a power up signal and short the power supply voltage and the first voltage.

4. The internal voltage generation circuit of claim 3, wherein the driver comprises an NMOS transistor.

5. The internal voltage generation circuit of claim 4, wherein the power enable signal is generated at a trigger time of the power up signal.

6. The internal voltage generation circuit of claim 1, further comprising a reset unit configured to generate a second voltage lower than a power supply voltage by a predetermined voltage level in an initial operation.

7. The internal voltage generation circuit of claim 6, wherein the reset unit comprises a driver configured to be turned on in response to the power supply voltage and generate the second voltage having a voltage level lower than the power supply voltage by a threshold voltage.

8. The internal voltage generation circuit of claim 1, wherein the level detection unit comprises:
a first divider configured to divide the first voltage to generate a division voltage; and
a comparator configured to compare the division voltage with a reference voltage and generate the level detection value.

9. The internal voltage generation circuit of claim 1, wherein the first voltage generation unit configured to pump a power supply voltage to generate the first voltage when a power-up signal is trigger.

10. The internal voltage generation circuit of claim 9, wherein the first voltage is a VPP voltage higher than the power supply voltage, and the second voltage is a VPPY voltage lower than the VPP voltage.

11. The internal voltage generation circuit of claim 1, wherein the second voltage generation unit comprises a pump unit configured to be enabled in response to the level detection value to pump a power supply voltage to generate the second voltage.

12. An internal voltage generation circuit, comprising:
a first voltage generation unit configured to be operated in response to a first power enable signal to generate a first voltage; and
a second voltage generation unit configured to be operated in response to a second power enable signal to generate a second voltage lower than the first voltage, the second power enable signal being activated relatively later than the first power enable signal.

13. The internal voltage generation circuit of claim 12, further comprising a first reset unit configured to be operated in response to a first power up signal to generate the first voltage equal to a power supply voltage in an initial operation.

14. The internal voltage generation circuit of claim 13, wherein the reset unit comprises a driver configured to be turned on in response to the first power up signal and short the power supply voltage and the first voltage.

15. The internal voltage generation circuit of claim 14, wherein the first power enable signal is generated at a trigger time of the first power up signal.

16. The internal voltage generation circuit of claim 13, comprising a second reset unit configured to generate the second voltage lower than a power supply voltage by a predetermined voltage level in an initial operation.

17. The internal voltage generation circuit of claim 16, wherein the reset unit comprises a driver configured to be turned on in response to the power supply voltage and generate the second voltage having a voltage level lower than the power supply voltage by a threshold voltage.

18. The internal voltage generation circuit of claim 17, wherein the second power enable signal is generated at a trigger time of the second power up signal being activated relatively later than the first power up signal.

19. The internal voltage generation circuit of claim 13, wherein the first voltage generation unit configured to pump the power supply voltage to generate the first voltage in response to the first power enable signal.

20. The internal voltage generation circuit of claim 18, wherein the first power enable signal comprises a power-up pre signal generated relatively earlier than a power-up signal.
